(19) United States
(12) Patent Application Publication
(10) Pub. No.: US 2011/0179572 A1
(43) Pub. Date: Jul. 28, 2011

(54) Stretcher pad with child restraint system

(76) Inventors: Marion Mohr, Bonn (DE); Alois Schnitzler, Niederkassel (DE)

(21) Appl. No.: 12/931,125

(22) Filed: Jan. 24, 2011

(30) Foreign Application Priority Data
Jan. 25, 2010 (DE) DE102010005619.7

(51) Int. Cl. A61G 1/044

(52) U.S. Cl. 5/628

(57) ABSTRACT

A stretcher pad comprises a mattress; a cuff fixed to an upper surface of the mattress; and a belt assembly arranged for securing one of a child and an infant being wrapped in the cuff; wherein a recess is formed in the mattress for accommodating at least part of the belt assembly; and a pouch is arranged on the mattress so as to cover the recess.

### CROSS-REFERENCE TO RELATED APPLICATIONS

The present application claims priority of German Patent Application No. 10 2010 005 619.7, filed Jan. 25, 2010, the content of which is hereby incorporated by reference in its entirety.

### FIELD OF THE INVENTION

The present application relates to stretcher pads, and in particular to stretcher pads which provide facilities to selectively secure either an adult or a child or infant to the stretcher.

### BACKGROUND OF THE INVENTION

The stretcher pad according to EP 1 318 782 B1 provides a combined patient restraint system consisting of a restraint system for adults in addition to a restraint system for children and infants.

In practice, it has been found that the restraint system currently not in use is cumbersome to stow, or else presents a source of irritation or even injury for the patient currently to be secured to the stretcher.

### SUMMARY OF THE INVENTION

In order to avoid the drawbacks of the prior art, according to a first aspect a stretcher pad comprises a mattress, a cuff fixed to an upper surface of the mattress, and a belt assembly arranged for securing one of a child and an infant being wrapped in the cuff, wherein a recess is formed in the mattress for accommodating at least part of the belt assembly, and a pouch is arranged on the mattress so as to cover the recess.

With this arrangement, a part of the belt assembly currently not in use can be stowed away in the recess below the pouch, to not thereby irritate or injure an adult person lying on the mattress and pouch. In addition, the cuff flaps may be used to stow other parts of the belt assembly toward both lateral sides of the stretcher pad.

Conversely, when a child or infant is to be transported with the stretcher, it may be secured with either the cuff (infant) or the belt assembly (child) as the case may be.

In either event, the patient is not irritated by components not actually in use, nor is there any danger of medical staff using inappropriate securing means.

According to another aspect, a stretcher pad comprises a mattress, a cuff fixed to an upper surface of the mattress, and a belt assembly arranged for securing one of a child and an infant being wrapped in the cuff, wherein the cuff comprises two laterally opposed flaps extending to either side from the upper surface of the mattress, each of the two laterally opposed flaps having a cutout section, the laterally opposed flaps being arranged for passing between the body and the respective arm of the child or infant in a state in which the child or infant is secured by the belt assembly and the cuff. In this manner, it is facilitated to securely wrap the child or infant with the cuff, while at the same time it is facilitated to securely fasten the cuff and the belt arrangement to the mattress.

According to yet another aspect, a stretcher pad comprises a mattress, a cuff fixed to an upper surface of the mattress, and a belt assembly arranged for securing one of a child and an infant being wrapped in the cuff, wherein a recess is formed in the mattress for accommodating at least part of the belt assembly, and wherein the cuff comprises two laterally opposed flaps extending to either side from the upper surface of the mattress, each of the two laterally opposed flaps having a cutout section, the laterally opposed flaps being arranged for passing between the body and the respective arm of the child or infant in a state in which the child or infant is secured by the belt assembly and the cuff. In this manner, the various advantages explained above are simultaneously achieved.

### BRIEF DESCRIPTION OF THE DRAWINGS

The foregoing as well as other advantageous features of the invention will be more apparent from the following detailed description of exemplary embodiments of the invention with reference to the accompanying drawings. Not all possible embodiments of the present invention necessarily exhibit each and every, or any, of the advantages identified herein.

FIG. 1 shows a first stretcher pad according to the invention;

FIG. 2a shows details of the stretcher pad of FIG. 1;

FIG. 2b shows a cross sectional view of the stretcher pad of FIG. 2a;

FIG. 3a shows the cuff of a second stretcher pad according to the invention, and

FIG. 3b shows the second stretcher pad in cross section.

### DETAILED DESCRIPTION OF EXEMPLARY EMBODIMENTS

In the exemplary embodiments described below, components that are alike in function and structure are designated as far as possible by alike reference numerals. Therefore, to understand the features of the individual components of a specific embodiment, the descriptions of other embodiments and of the summary of the invention should be referred to.

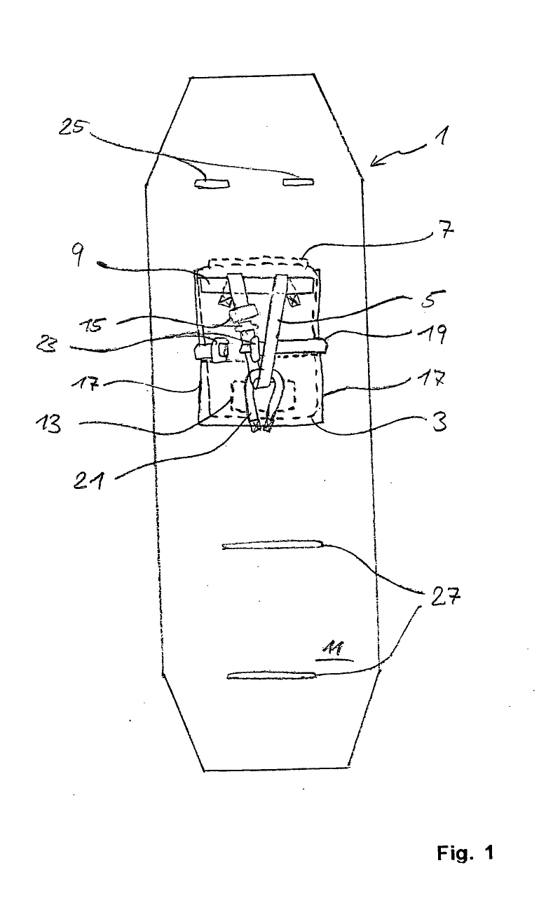

The stretcher pad 1 shown in FIG. 1 includes a pouch 3 arranged in a breast area, within which shoulder straps 5 are sewn or otherwise secured to the mattress. The pouch has a zipper 7 at its head-side end, with which zipper it may be closed to stow the shoulder straps when not in use. Within the pouch, near its feet-side end, a rectangular, round or otherwise shaped recess 13 is formed in the foam material of the mattress 11, for accommodating at least the belt lock 15 or a belt adjustment mechanism when the belt assembly 5 is not in use. A retainer strap 9 fixed on top of the part of the shoulder straps 5 and arranged within the pouch 3 is guided through holes in the mattress to the back side thereof, where both ends of the retainer strap 9 are connected e.g. by a nut-and-bolt connection or in some other suitable manner. If desired, the retainer strap 9 may be reinforced with a laterally oriented, flat plastic bar.

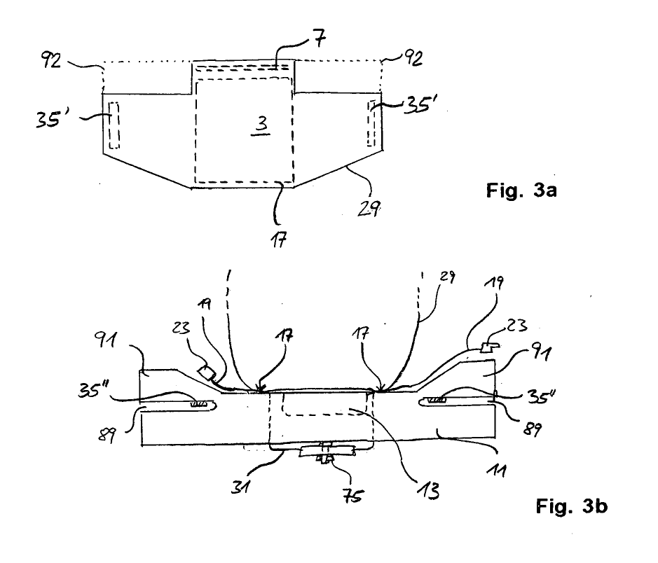

The outer, top part of the pouch 3 has rectangular or trapezoidal flaps (not shown in FIG. 1, but in FIG. 3a) on either outer, lateral side formed integrally with it, wherein the flaps are sewn 17 and additionally adhered to the surface of the mattress. Together, these items provide a cuff for children or infants to be transported. Close to the outer rims of the flaps, loop-components of a hook-and-loop fastening system are arranged, and the complementary hook-components are arranged beyond the outer rim of the mattress, either on its back side or preferably in a lateral recess extending in a longitudinal direction of the mattress 11. In this arrangement, when the cuff is not in use, the flaps can be releasably secured to the outer sides by bringing their loop-components 35′ together with the hook-components 35″. The width of the flaps in a lateral direction accordingly matches the distance to the hook-components 35″. At the same time, in this state the flaps cover and secure either end of a waist belt 19 to the outside. In use, the waist belt 19 surrounds both flaps of the cuff, wherein the ends of the waist belt are fixed to the mattress' surface laterally outside of the flaps, and preferably in the same area where the longitudinal recess formed in the mattress' sides ends. Similarly as the retainer strap 9 for the shoulder straps 5, the ends of the waist belt 19 are guided through holes in the mattress to the back side thereof, where both ends of the waist belt 19 are connected e.g. by a nut-and-bolt connection or in some other suitable manner. Where the cuff contacts the mattress, or at least at a circumference of such contact area, the cuff is welded to the mattress in order to in use avoid contamination with body fluids. In addition, at the point where the waist belt 19 penetrates the surface of the mattress, a sealing material such as an adhesive is provided so that no blood or other body fluid can enter the space in between.

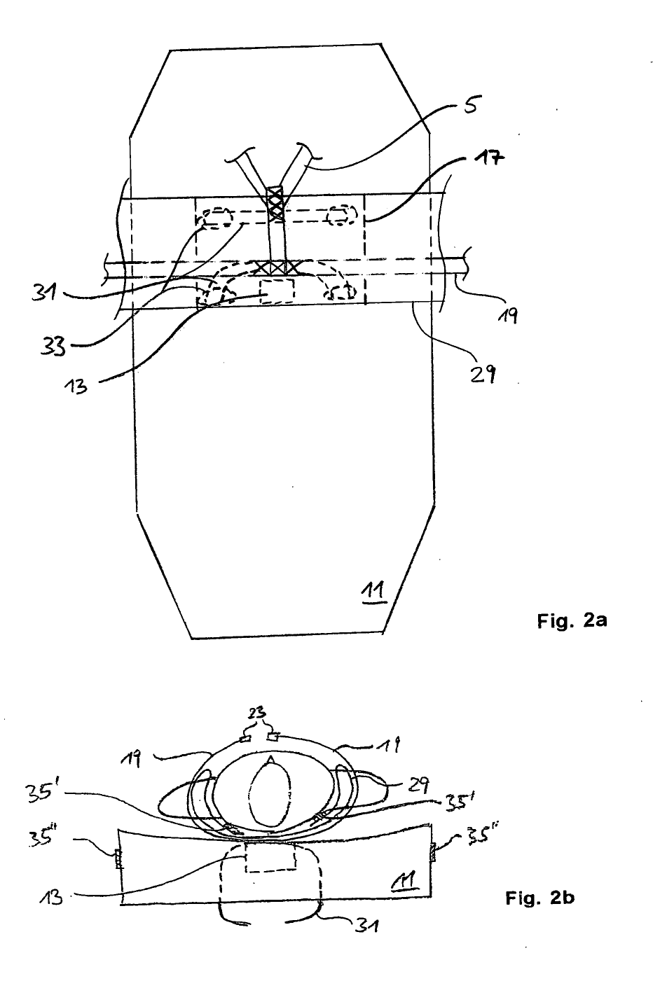

At the position where the recess 13 is formed in the surface of the mattress, the back-side of the pouch has an opening of matching size. In FIG. 2a, one possible way of attaching the various belts to the mattress 11 is shown, the flaps 29 of the cuff being shown in the open state, their outer ends not fixed to the mattress 11. In this variant, the waist belt ends and the shoulder strap 5 ends are fixed to two spaced apart retainer straps 31, which are guided through holes 33 in the mattress to the back side thereof. The same arrangement is also shown in FIG. 2b in cross section, which also shows how a child (as opposed to an infant) is transported with the flaps 29 folded inside, but still protecting the child's sides, and the waist belt ends 19 being arranged to be connected by the belt lock 23. The hook-components 35″ (shown in their idle state) are arranged on the outer lateral side of the mattress, which in this less preferred variant still encompassed by the invention, has no longitudinal recess. In another variant, it is possible to arrange the hook-components on the back-side of the mattress, as long as they do not interfere with the stretcher itself. In the arrangement according to FIG. 2a, the shoulder straps 5 are shown as being sewn together in a Y-shape, which is a preferable alternative to the separate attachment as shown in FIG. 1. In FIG. 2a, a weld 17 surrounds the contact area between cuff 29 and mattress 11. Note that when an infant is to be transported, neither flap is not folded, but both wrap the infant. In this context, an infant is meant to be a particularly young or small child.

If required, a crotch strap 21 shown in FIG. 1 may be provided, although usually not necessary. If present, ends of such crotch strap 21 may carry components of a belt lock 23 and an adjustment loop, as may the shoulder straps 5. In use, the loop formed by the shoulder straps 5 surrounds the waist belt and, if present, a loop formed by the crotch strap 21 either also surrounds the waist belt or is otherwise joined to the shoulder straps. In this case, a single crotch strap may be present, if desired.

FIG. 3a shows a modified arrangement of the cuff with the central part forming the pouch 3 and the laterally opposed flaps 29 having cut-out sections 92 (dotted lines) at their head-side ends allowing, in use, the flaps to be arranged between the body of the child or infant to be secured, and its arms (the skilled person will note that only the cuff is shown in FIG. 3a, the mattress being omitted for the purpose of clarity only). Thereby, the flaps provide a secure stop hindering the transported child or infant to slip through towards the feet end even in case of being carried upwards, or the transporting vehicle having an accident. The loop-components 35′ are indicated by dashed lines, as in this view they are positioned on the far side of the flaps. In this example, the feet-end rim of the flaps is obliquely shaped, so that the overall shape is trapezoidal. Other shapes, such as rectangular, or rounded, are also possible. Meanwhile, the shoulder straps (not shown in FIG. 3a) provide a similar stop against movement towards the head end, and the cuff together with the waist straps 19 secures the child or infant against acceleration away from the mattress. In this manner, the transported child or infant remains attached to the mattress even in case of the transporting vehicle overturning in the event of an accident, without a crotch strap being necessary. In FIG. 3b, a cross-section of the mattress 11 with lateral wedge-shaped portions 91 is shown. Between the wedge-shaped portions 91 and the bottom layer of the mattress 11, longitudinally extending recesses 89 are formed, in which the corresponding hook-components 35″ are accommodated. In the FIG. 3b, the cuff 29 and flaps, connected to the mattress 11 at welds 17, are not shown in their full extent for simplicity. Again, the ends 31 of the waist belt 19 are connected at the back of the mattress by a nut-and-bolt connector 75, as are ends of the shoulder retainer strap which is located approximately between the cutout sections.

Apart from the details of the belt arrangement 5, 19, 21 for transportation of a child or infant, the mattress 11 has two substantially laterally oriented slits 25 for guiding shoulder straps for adult persons therethrough. Further, the foam layer of the leg portion of the mattress 11 has at least one or two laterally arranged interruptions 27 as shown in FIG. 1 in order to provide foldability of the mattress, thereby allowing its stowing away in a small compartment, e.g. in a transportation vehicle, such as an ambulance or heli-copter. Similar interruptions may be provided where the slits 25 are provided, and at the bottom end of the pouch (not shown). Near the head end of the mattress, there may be provided further Velcro (hook-and-loop) components (not shown) which may serve to attach a pillow or the like carrying the complementary components.

As for the materials preferably used, all the belts may, without limitation, be made from polyester. The belt locks are preferably made from a suitable metal. An exemplary mattress 11 has a layered structure with a PVC bottom layer, a foamed interior and a synthetic leather top layer. The hook-and-loop fasteners 35′, 35″ are preferably, without limitation, made from weldable polyamide, while the zipper 7 is made from a suitable plastic material. The shoulder straps 5 preferably have sheaths made from synthetic leather. It is advisable to provide the polyester straps with synthetic leather sheaths wherever they are guided through e.g. the top and bottom layers of the mattress to prevent wear.

While the invention has been described with respect to certain exemplary embodiments thereof, it is evident that many alternatives, modifications and variations will be apparent to those skilled in the art. Accordingly, the exemplary embodiments of the invention set forth herein are intended to be illustrative and not limiting in any way. Various changes may be made without departing from the spirit and scope of the present invention as defined in the following claims.

Having thus described the invention, what is claimed is:

1. A stretcher pad, comprising:
a mattress;
a cuff fixed to an upper surface of the mattress;
a belt assembly arranged for securing one of a child and an infant being wrapped in the cuff;
wherein a recess is formed in the mattress for accommodating at least part of the belt assembly; and
a pouch is arranged on the mattress so as to cover the recess.

2. The stretcher pad of claim 1, wherein the belt assembly comprises at least one of a belt lock assembly and a belt adjustment assembly arranged to be accommodated in the recess.

3. The stretcher pad of claim 1, wherein the pouch has a closable lid arranged to provide access to the recess.

4. The stretcher pad of claim 1, wherein the cuff includes two laterally opposed flaps each having a cutout section, whereby the laterally opposed flaps are adapted for passing between the body and the respective arm of the child or infant in a state in which the child or infant is secured by the belt assembly and the cuff.

5. A stretcher pad, comprising:
a mattress;
a cuff fixed to an upper surface of the mattress;
a belt assembly arranged for securing one of a child and an infant being wrapped in the cuff;
wherein a recess is formed in the mattress for accommodating at least part of the belt assembly; and
wherein the cuff comprises two laterally opposed flaps extending to either side from the upper surface of the mattress, each of the two laterally opposed flaps having a cutout section, whereby the laterally opposed flaps are arranged for passing between the body and the respective arm of the child or infant in a state in which the child or infant is secured by the belt assembly and the cuff.

6. The stretcher pad of claim 5, wherein the belt assembly comprises at least one of a belt lock assembly and a belt adjustment assembly arranged to be accommodated in the recess.

7. The stretcher pad of claim 5, further comprising a pouch arranged on the mattress so as to cover the recess, wherein the pouch has a closable lid arranged to provide access to the recess.

8. A stretcher pad, comprising:
a mattress;
a cuff fixed to an upper surface of the mattress, and
a belt assembly arranged for securing one of a child and an infant being wrapped in the cuff,
wherein the cuff comprises two laterally opposed flaps extending to either side from the upper surface of the mattress, each of the two laterally opposed flaps having a cutout section, whereby the laterally opposed flaps are arranged for passing between the body and the respective arm of the child or infant in a state in which the child or infant is secured by the belt assembly and the cuff.

9. The stretcher pad of claim 8, wherein a recess is formed in the mattress for accommodating at least part of the belt assembly; and wherein the belt assembly comprises at least one of a belt lock assembly and a belt adjustment assembly arranged to be accommodated in the recess.

10. The stretcher pad of claim 9, wherein a pouch is arranged on the mattress so as to cover the recess.

11. The stretcher pad of claim 10, wherein the pouch has a closable lid arranged to provide access to the recess.

12. The stretcher pad of claim 1, wherein the belt assembly comprises a waist strap and shoulder straps arranged to pass around the waist strap in the closed state.

13. The stretcher pad of claim 5, wherein the belt assembly comprises a waist strap and shoulder straps arranged to pass around the waist strap in the closed state.

14. The stretcher pad of claim 8, wherein the belt assembly comprises a waist strap and shoulder straps arranged to pass around the waist strap in the closed state.

15. The stretcher pad of claim 12, wherein the waist strap comprises a right side section and a left side section arranged to be connected by a belt lock, each of the right side section and the left side section being fastened to the mattress in an area between the flap of the cuff on the respective side, and the outer rim of the mattress.

16. The stretcher pad of claim 13, wherein the waist strap comprises a right side section and a left side section arranged to be connected by a belt lock, each of the right side section and the left side section being fastened to the mattress in an area between the flap of the cuff on the respective side, and the outer rim of the mattress.

17. The stretcher pad of claim 14, wherein the waist strap comprises a right side section and a left side section arranged to be connected by a belt lock, each of the right side section and the left side section being fastened to the mattress in an area between the flap of the cuff on the respective side, and the respective outer rim of the mattress.

18. The stretcher pad of claim 15, wherein each of the right side flap of the cuff and the left side flap of the cuff are arranged for being releasably fastened to the mattress in an area beyond the outer rim of the surface of the mattress in a non-use state of the cuff.

19. The stretcher pad of claim 16, wherein each of the right side flap of the cuff and the left side flap of the cuff are arranged for being releasably fastened to the mattress in an area beyond the outer rim of the surface of the mattress in a non-use state of the cuff.

20. The stretcher pad of claim 17, wherein each of the right side flap of the cuff and the left side flap of the cuff are arranged for being releasably fastened to the mattress in an area beyond the outer rim of the surface of the mattress in a non-use state of the cuff.
